(19) United States
(12) Patent Application Publication
(10) Pub. No.: US 2002/0113062 A1
(43) Pub. Date: Aug. 22, 2002

(54) Timer controlled stove/oven

(76) Inventor: Michael D. Cranford, Montgomery, AL (US)

Correspondence Address: Richard C. Litman, LITMAN LAW OFFICES, LTD., P. O. Box 15035, Arlington, VA, 22215, US

(21) Appl. No.: 09/785,225

(22) Filed: Feb. 20, 2001

(51) Int. Cl. H05B 1/02; H05B 3/68

(52) U.S. Cl. 219/518; 219/412; 219/492; 219/493; 219/497; 219/447.1

(57) ABSTRACT

A timer control system for operating an electric or gas cooktop stove with an oven and broiler. Automatic shut off weight sensitive sensors for shutting off the stove top heating elements and the oven and broiler elements after a prescribed interval of time are integrated with the stove top heating elements, the oven element and the broiler element. If a weight, i.e., food in a utensil, is placed on any active burner element, the timer control is negated and the heating will continue. Push button controls are located on a rear panel on top of the stove.

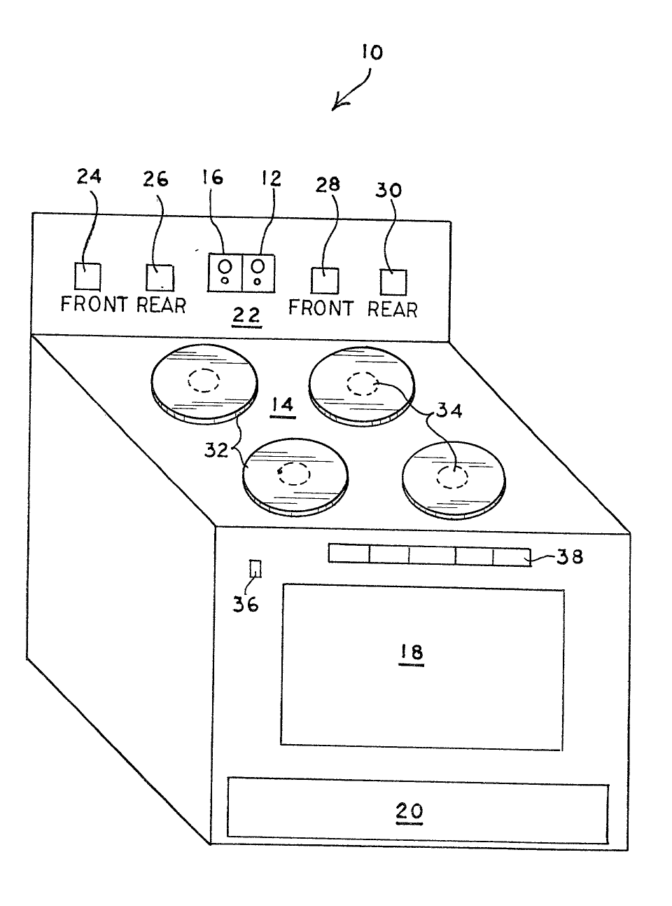

### BACKGROUND OF THE INVENTION

1. Field of the Invention

The present invention relates generally to automatic controls for a combination stove and oven. More specifically, the invention relates to a timer controlled electric or gas cooktop stove with an oven. Automatic sensors for shutting off the stove and oven after a prescribed interval of time are integrated with the stove top heating elements and the oven elements. Push button controls are located on a rear panel on top of the stove.

2. Description of Related Art

The related art of interest describe various timing devices and systems for appliances. The related art will be discussed in order of perceived relevance to the present invention.

U.S. Pat. No. 5,491,423, issued on Feb. 13, 1996 to Daniele Turetta, describes a device for detecting the presence of a food container such as a saucepan, dish, etc. on a glass ceramic cooking hob energized by either an electrical resistor, a halogen lamp or a gas burner. Electrical conductor rings on the cooking hob are fed with electrical signals 180° out of phase. If the saucepan is removed from the cooking hob, the heat is reduced, and the heat is turned off if the saucepan is not returned to the hob within a predetermined time period such as a minute as measured by a clock. The power controller is a solenoid valve for gas, a potentiometer for an electrical resistor, or a conventional halogen controller. The device is distinguishable for its limitation to a glass ceramic cooking hob with four specific functioning rings.

U.S. Pat. No. 5,243,172, issued on Sep. 7, 1993 to Hazan et al., describes a cook-top with automatic controls which detect the presence of cooking utensils on cooking sections. The detectors actuate a timer in order to turn off or to reduce the heating of the cooking section when the utensil has been removed, and to turn on the heat when the utensil is placed back on the cooking surface if the absence time has been shorter than a given time. The detector can be responsive to the weight of the utensil and/or the temperature of the heating surface. The presence detectors can be either a capacitive detector, an inductive detector, a light emitter and receiver, or an ultrasonic emitter and receiver. The cook-top is distinguishable for not effecting an automatic shut off of the heat by the stove and oven burners if they are not being used by a cooking utensil after a predetermined period.

U.S. Pat. No. 4,467,184, issued on Aug. 21, 1984 to Mark C. Loessel, describes a thermal range control for an oven having a manually settable timer for establishing preselected broiling and baking times. A microcomputer with a keyboard and indicator lights control the warning system. The control includes an alarm and circuitry for sounding the end of the timed cooking period. If the user does not turn off the burners after a short preselected time after the sounding of the intermittent alarm, the burners will be automatically de-energized. The control system is distinguishable for requiring a microcomputer, an audible alarm and a keyboard.

U.S. Pat. No. 5,486,685, issued on Jan. 23, 1996 to W. Jean Dodds, describes an oven with a food presence indicator by either detecting the weight of the food or the interruption of a light beam. A time delay is provided for the detection of the weight and the activation of the indicator. The apparatus is distinguishable for its limitation to the location of food for heating.

U.S. Pat. No. 5,183,996, issued on Feb. 2, 1993 to Hazan et al., describes a cook-top which includes a plurality of heating elements equipped with strain-gauge modules which detect the weight on the cook-top plate. The center of gravity of the combined forces is computed and controls identify a heating element whose load has varied for reducing or turning off the electrical power supply. The function controls can be pressure-sensitive touch controls. The apparatus is distinguishable for the use of strain gauge modules and computer use for determining the specific gravity of the combined weight of the cooking utensils with food.

U.S. Pat. No. 5,520,095, issued on May 28, 1996 to Huber et al., describes an automatic loading display for catering equipment wherein the cooking equipment has parallel rails for defining positions for each container in the cooking chamber. A sensor arrangement based on a microcomputer controller determines the presence of a container at a shelf position, temperature, moisture content, and door position. A timer receives the output of the sensor to start timing of the cooking duration and creating an output signal at the end of the cooking duration which is applied to a display to indicate the completion of the cook of the particular container. The catering equipment is distinguishable for its reliance on only the cooking time.

German Patent Publication No. 2,831,858, published on Feb. 7, 1980, describes a cooking plate system, as best understood, comprising a transparent cook plate energized by electrical power by a system including an oscillator, sensors, a comparator, and a power control with a filter. The system is distinguishable for the absence of timers.

Japan Patent Publication No. 58-106334, published on Jun. 24, 1983, describes a portable electric stove, as best understood, with four electric coils and front controls including a timer for turning off any heating coil. The stove is distinguishable for the absence of timers for synchronizing the turn off of power when a pot is not used.

None of the above inventions and patents, taken either singly or in combination, is seen to describe the instant invention as claimed.

### SUMMARY OF THE INVENTION

The present invention relates to a timer controlled electric or gas cooktop stove with an oven. Automatic shut off sensors for shutting off the stove or oven after a prescribed interval of time if no pot or cooking container is placed on the burner or oven rack are integrated with the stove top heating elements and the oven elements. Push button controls are located on a rear panel on top of the stove.

Accordingly, it is a principal object of the invention to provide a timer control for a combined stove and oven for an automatic shut off of a burner element after a prescribed time interval if not utilized.

It is another object of the invention to provide a timer control for a combined stove and oven operating on either gas or electric power.

It is a further object of the invention to provide a timer control for a combined stove and oven responsive to sensors based on the cooking and baking elements.

Still another object of the invention is to provide a timer control for a combined stove and oven responsive to separate push button controls.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawing.

### BRIEF DESCRIPTION OF THE DRAWING

The sole FIGURE is a front perspective view of a timer controlled stove/oven according to the present invention.

### DETAILED DESCRIPTION OF THE PREFERRED EMBODIMENT

The present invention 10 as depicted by the FIGURE is shown schematically and includes a push-button timer control 12 for a stove or range 14 and a push-button timer control 16 for an oven 18 and broiler 20. An internal microcomputer chip (not shown) drives the various electronic components of the invention 10 by conventional wiring. The push-button timer controls 12, 14 are conveniently located on a rear panel 22 along with the on/off temperature dial burner controls 24 (left front), 26 (left rear), 28 (right front), and 30 (right rear).

Each burner 32 has a weight detecting sensor 34 located in its center. The burners and racks in the oven 18 and the broiler 20 are not shown but are conventionally located.

Other features of a conventional oven are shown as a push-button switch 36 for the oven light (not shown) and the oven door handle 38.

The present invention is designed for the user who does not have the time to watch the food cook. The stove top timer 12 when pushed in will automatically shut off the specific burner 32 activated by one or more of the on/off and temperature control controls 24, 26, 28, and 30, after a predetermined time period of, say three minutes, if a food-containing pot or utensil has not been placed on the heated burner of the stove 12. For the oven 18 or broiler 20, the oven or broiler sensor 34 (not shown) will be activated by the push-button timer control 16; and the sensor will turn off automatically after, say 20 minutes, if the sensor does not detect additional weight being placed on the oven or broiler rack. The longer length of time is required because normally the cooker must preheat the oven 18 or broiler 20 before placing the food inside.

It should be noted that the weight detecting sensors 34 in the oven 18 and the broiler 20 can be distributed in an array in the racks. The timer control system can be utilized for either a natural gas, propane or an electric cooking appliance.

Thus, the invention is advantageous in being an economical addition to a stove 14 with an oven 18 and a broiler 20 at the time of manufacture, simple and economical to operate, and minimizes the danger of overheating any of the burners 32.

It is to be understood that the present invention is not limited to the sole embodiment described above, but encompasses any and all embodiments within the scope of the following claims.

I claim:

1. A timer control system for a combination stove with oven and broiler elements comprising:
a combination stove and oven housing having a plurality of burner elements, an oven element and a broiler element, and having a rear top control panel, the stove being operable on an energy source;
a weight sensor element for each said burner element of the stove, and for the oven element and the broiler element;
a first push-button control located on said rear top control panel for each burner element on the stove;
a second push-button control located on said rear top control panel for the oven element and the broiler element; and
a push-button timer control located on said rear top control panel for shutting off said burner elements, the oven element and the broiler element when the weight sensor elements fail to detect a cooking utensil being placed on the elements after a predetermined time period; and
wherein the timer control period is for a shorter time for each weight sensor element of said stove burner elements and for a longer time for the weight sensor element of the oven element and broiler element.

2. The system according to claim 1, including a programmed capacity of each stove, oven and broiler burner element to automatically stay on when a weight is placed on the burner element within the programmed timer control period.

3. The system according to claim 1, wherein the stove is operable on a natural gas energy source.

4. The system according to claim 1, wherein the stove is operable on an electrical power source.

5. The system according to claim 1, wherein the stove is operable on a propane power source.

6. The system according to claim 1, wherein the weight sensor elements are arranged in an array in the racks of the oven element.

7. The system according to claim 1, wherein the weight sensor elements are arranged in an array in the racks of the broiler element.
